(19) United States
(12) Patent Application Publication
(10) Pub. No.: US 2023/0083508 A1
(43) Pub. Date: Mar. 16, 2023

(54) Casing for Battery and Battery

(71) Applicant: Xiamen Hithium Energy Storage Technology Co., Ltd., Xiamen (CN)

(72) Inventors: Bo HE, Xiamen (CN); Weidong XU, Xiamen (CN); Nan ZHANG, Xiamen (CN); Ziqi YI, Xiamen (CN); Zuyu WU, Xiamen (CN)

(21) Appl. No.: 17/902,996

(22) Filed: Sep. 5, 2022

(30) Foreign Application Priority Data
Sep. 10, 2021 (CN) 202122186817.0

(51) Int. Cl. H01M 50/133; H01M 50/107; H01M 50/169

(52) U.S. Cl. CPC H01M 50/133; H01M 50/107; H01M 50/169

(57) ABSTRACT

The present invention discloses a casing for a battery and a battery. The casing for the battery comprises a body. The body comprises a shell and at least one cover; at least one end of the shell is open; the cover is arranged at the one end of the shell; the shell comprises at least one first shell portion and a second shell portion which are connected to each other; the first shell portion is opposite to the cover; a thickness of the first shell portion is larger than that of the second shell portion; and a mounting portion is arranged at one end of the shell.

### CROSS REFERENCE TO RELATED APPLICATION

The present disclosure claims the benefit of priority to Chinese patent application No. 202122186817.0, filed on Sep. 10, 2021 to China National Intellectual Property Administration and titled “Casing for Battery and Battery”, which is incorporated herein by reference in its entirety.

### TECHNICAL FIELD

The present invention relates to the technical field of batteries, in particular to a casing for a battery and a battery.

### BACKGROUND

In the prior art, if a thickness of a shell for a battery is not reasonably set, a space for accommodating a winding core in the shell cannot be guaranteed; waste of materials for manufacturing the shell is easily caused; a space of the shell is reduced, the energy density of the winding core inside is lowered; and a weight of the battery is too large, which results in increase a weight and a volume of equipment using the battery, too high cost and lowering in market competitiveness.

### SUMMARY

The present invention aims to at least solve one of the technical problems in the prior art. For this reason, an objective of the present invention is to propose a casing for a battery and a battery.

The casing for the battery according to an embodiment of the present invention comprises a body. The body comprises a shell and at least one cover; at least one end of the shell is open; the cover is arranged at the one end of the shell; the shell comprises at least one first shell portion and a second shell portion which are connected to each other; the first shell portion is opposite to the cover; a thickness of the first shell portion is larger than that of the second shell portion; and a mounting portion is arranged at the one end of the shell.

Thus, the thickness of the first shell portion is larger than that of the second shell portion, which may guarantee a connection strength between the first shell portion and the cover; the mounting portion may improve the stability and the reliability of mounting of the shell and the cover; and meanwhile, the thickness of the second shell portion is thinner, which may facilitate widening in the space in the shell, increases the energy density of the winding core and lowers the weight and the material cost.

In some embodiments, an inner surface of the first shell portion is flush with that of the second shell portion.

In some embodiments, a transition portion is connected between the first shell portion and the second shell portion and has a thickness gradually increasing in a direction from the second shell portion toward the first shell portion.

In some embodiments, a thickness of one end, connected with the first shell portion, of the transition portion is D₁, and a thickness of the other end, connected with the second shell portion, of the transition portion is D₂, wherein D₁ and D₂ satisfy: D₁−D₂≥0.1 mm.

In some embodiments, a height of the first shell portion in an axial direction of the shell is larger than the thickness of the cover.

In some embodiments, the mounting portion is configured as a step portion; the step portion is arranged at one end of the shell; and the cover is supported on the step portion.

In some embodiments, the step portion comprises a first step section and a second step section which are connected to each other from inside to outside; one end, away from the center of the shell, of the second step section extends beyond an end surface at one end, away from the center of the shell, of the first step section; the cover is supported on the end surface at the one end, away from the center of the shell, of the first step section; and the first step section has a thickness D₃, wherein D₃ satisfies: D₃≥0.1 mm.

In some embodiments, the end surface at the one end of the shell is flush with a surface on one side, away from the center of the shell, of the cover.

In some embodiments, the cover is connected with the shell by welding.

The battery according to an embodiment in second aspect of the present invention comprises the casing for the battery according to any one of the embodiments.

The additional aspects and the advantages of the present invention will be partially set forth in the following description, and in part will be apparent from the following description, or may be learned by practice of the present invention.

### BRIEF DESCRIPTION OF FIGURES

The mentioned-above and/or additional aspects and advantages of the present invention will be apparent and easily understood in descriptions of the embodiments in combination with the following drawings, wherein

FIG. 1 is a schematic diagram of a body according to an embodiment of the present invention.

FIG. 2 is an enlarged view of a P region in FIG. 1.

FIG. 3 is a schematic diagram of a shell according to an embodiment of the present invention.

FIG. 4 is a schematic diagram of a shell according to another embodiment of the present invention.

### REFERENCE NUMERALS

body 100;

shell 10; first shell portion 11; second shell portion 12; transition portion 13;

step portion 14; first step section 141; second step section 142.

### DETAILED DESCRIPTION

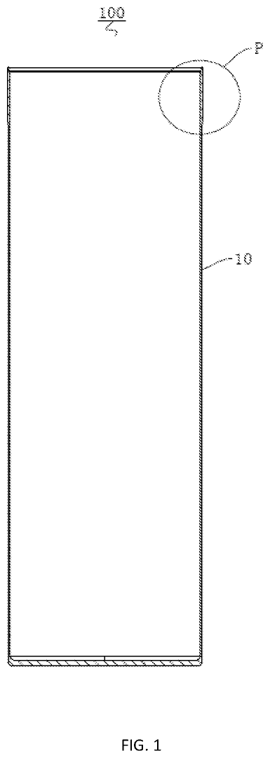

The embodiments of the present invention are described in detail below; the embodiments described with reference to the drawings are illustrative; and a casing for a battery and a battery according to the embodiments of the present invention are described with reference to FIGS. 1-4 below.

The casing for the battery according to an embodiment of the present invention comprises a body 100. The body 100 comprises a shell 10 and at least one cover; at least one end of the shell 10 is open; the cover is arranged at the one end of the shell 10; the shell 10 comprises at least one first shell portion 11 and a second shell portion 12 which are connected to each other; the first shell portion 11 is opposite to the cover; a thickness of the first shell portion 11 is larger than that of the second shell portion 12; and a mounting portion is arranged at one end of the shell 10.

As shown in FIGS. 1-4, the first shell portion 11 and the second shell portion 12 are distributed in an axial direction of the body 100 in sequence; at least one end of the two ends of each of the first shell portion 11 and the second shell portion 12 is open, wherein the mounting portion is arranged at one end, away from the second shell portion 12, of the first shell portion 11 to facilitate mounting and fixing of the cover; and a wall thickness of the first shell portion 11 is larger than that of the second shell portion 12.

Thus, one end, away from the second shell portion 12, of the first shell portion 11 adapts to the cover; the thickness of the first shell portion 11 is larger than that of the second shell portion 12, which may guarantee a connection strength between the first shell portion 11 and the cover; the mounting portion may improve the stability and the reliability of mounting of the shell 10 and the cover; and meanwhile, the thickness of the second shell portion 12 is thinner, which may facilitate widening in the space in the shell 10, increases the energy density of the winding core and lowers the weight and the material cost.

In some embodiments, an inner surface of the first shell portion 11 is flush with that of the second shell portion 12. That is, a diameter of an inner wall of the first shell portion 11 is identical to that of an inner wall of the second shell portion 12, and an extension of a central axis of the first shell portion 11 coincides with that of a central axis of the second shell portion 12; and at this time, an outer surface of the first shell portion 11 protrudes from an outer surface of the second shell portion 12. Thus, the inner surface of the first shell portion 11 is flush with that of the second shell portion 12, which may increase a space in the shell 10, weakens the effect on the winding core mounted inside and facilitates mounting of the winding core.

Certainly, in another some embodiments, the inner surface of the first shell portion 11 may protrude from the inner surface of the second shell portion 12; and the outer surface of the first shell portion 11 is flush with that of the second shell portion 12. Or the outer surface of the first shell portion 11 may protrude from the outer surface of the second shell portion 12, and the inner surface of the first shell portion 11 may protrude from the inner surface of the second shell portion 12 at the same time. The above three situations may be specifically set according to the actual needs, which is not limited here.

Further, a transition portion 13 is connected between the first shell portion 11 and the second shell portion 12 and has a thickness gradually increasing in a direction from the second shell portion 12 toward the first shell portion 11.

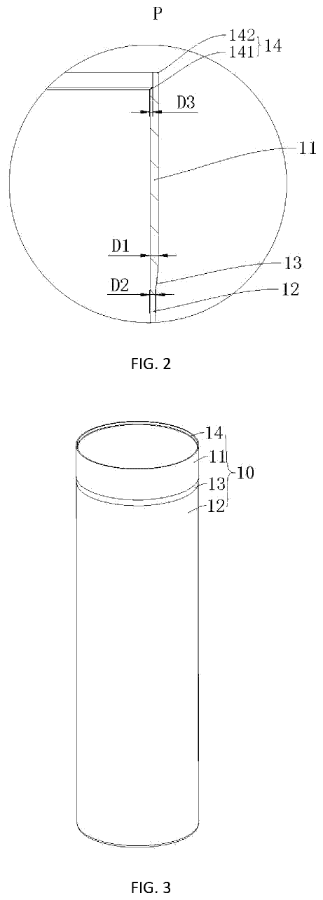

As shown in FIG. 2, the transition portion 13 is arranged at a connection part between the first shell portion 11 and the second shell portion 12 and is gradually inclined away from a side wall of the first shell portion 11 in a direction from one side, on which the second shell portion 12 is located, toward one side, on which the first shell portion 11 is located; that is, a thickness of one side, close to the cover 12, of the transition portion 13 in the radial direction of the first shell portion 11 is larger than that of one side, close to the second shell portion 12, of the transition portion 13 in the radial direction of the first shell portion 11.

Thus, the transition portion 13 for connecting the first shell portion 11 to the second shell portion 12 is inclined, so that transition between the first shell portion 11 and the second shell portion 12 is smooth; occurrence of corner angles is reduced; and smoothness of an exterior of the shell 10 is improved. Meanwhile, one end, close to the cover, of the transition portion has a larger thickness, which facilitates improvement in supporting to the cover and structure strength of the shell 10 of the battery.

Specifically, as shown in FIG. 2, the thickness of one end, connected to the first shell portion 11, of the transition portion 13 is D₁, and the thickness of one end, connected to the second shell portion 12, of the transition portion 13 is D₂, wherein D₁ and D₂ satisfy: D₁−D₂≥0.1 mm. As the one end, connected to the first shell portion 11, of the transition portion 13 is flush with the surface of the side wall of the first shell portion 11, and the one end, connected to the second shell portion 12, of the transition portion 13 is flush with the surface of the side wall of the second shell portion 12, a thickness difference between the two ends of the transition portion 13 is a difference between the side wall of the first shell portion 11 and the side wall of the second shell portion 12 in a radial direction away from the center of the shell 10.

Thus, by defining the thickness (in the radial direction) difference between the two ends, at the first shell portion 11 and the second shell portion 12, of the transition portion 13, while the shell 10 satisfies the structure strength and better supports the cover, the weight of the shell 10 is lowered; the portability of casing using the shell 10 is improved; and the weight of the battery may be lowered.

Optionally, a height of the first shell portion 11 in an axial direction of the shell 10 is larger than a thickness of the cover. Thus, a length of the first shell portion 11 in the axial direction of the shell 10 is larger than that of the cover in the axial direction of the shell 10, so that the cover can completely extend into the first shell portion 11 to achieve sealing and mounting of the cover to the first shell portion 11.

As shown in FIGS. 2-3, the mounting portion is configured as the step portion 14; the step portion 14 is arranged at one end of the shell 10; and the cover is supported on the step portion 14. The step portion 14 is located on one side, close to the cover, of the first shell portion 11 and may form adaption to a side wall of the cover. Certainly, the mounting portion may further be a mounting groove, and the shell 10 may be mounted in the mounting groove; and the mounting portion may further be a boss, the cover has a flange, and the flange is matched with an outer edge mounted on the boss, which is not limited here.

Thus, the step portion 14 is arranged at one end, close to the cover, of the shell 10, which may facilitate positioning, improve the supporting performance of the shell 10 to the cover and the sealing effect of the cover to the shell 10, prevent an electrolyte from flowing out of the shell 10 and improve the safety of using the battery.

Further, the step portion 14 comprises a first step section 141 and a second step section 142 which are connected to each other from inside to outside; one end, away from the center of the shell 10, of the second step section 142 extends beyond an end surface at one end, away from the center of the shell 10, of the first step section 141; the cover is supported on the end surface at the one end, away from the center of the shell 10, of the first step section 141; and the first step section 141 has a thickness D₃, wherein D₃ satisfies: D₃≥0.1 mm. For example, D₃=0.1 mm.

As shown in FIG. 2, the first step section 141 and the second step section 142 are arranged at the end part, away from the second shell portion 12, of the first shell portion 11; the first step section 141 is located on one side, close to the center of the shell 10, of the second step section 142; and a vertical distance from the surface on one side, close to the center of the shell 10, of the first step section 141 to the surface on one side, close to the center of the shell 10, of the second step section 142 is D₃. The surface on one side, away from the center of the shell 10, of the second step section 142 is flush with the surface of the first shell portion 11; and the second step section 142 exceeds one end of the first step section 141 by a distance in the axial direction of the shell 10.

Thus, the step portion 14 is arranged at one end, away from the second shell portion 12, of the first shell portion 11 to achieve effective supporting to the cover by the first shell portion 11; and then limiting to the cover is formed on the inner side of the first shell portion 11, mounting of the cover is facilitated, and the sealing performance of the battery after the cover and the shell 10 are mounted is improved.

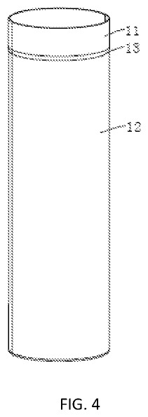

Optionally, as shown in FIG. 4, the step portion 14 is not arranged at the end part, away from the center of the shell 10, of the first shell portion 11; and the first shell portion 11 is different from the second shell portion 12 in that a length of the first shell portion 11 in an axial direction is smaller than the second shell portion 12, and a length of the first shell portion 11 in the radial direction is larger than the second shell portion 12 in the radial direction of the shell 10.

Specifically, the end surface at one end of the shell 10 is flush with the surface on one side, away from the center of the shell 10, of the cover. That is, the end surface at one end, away from the second shell portion 12, of the first shell portion 11 is flush with the end surface at one end, away from the shell 10, of the cover. Thus, the end surface at one end of the shell 10 is flush with the surface on one side, away from the center of the shell 10, of the cover, so that the surface of the formed battery is smoother, a structure of a space in the battery is compacter, and miniaturization and integration of the battery are facilitated.

In some embodiments, the cover is connected to the shell 10 by welding. The side wall of the cover adapts to the step portion 14 at one end, away from the second shell portion 12, of the first shell portion 11; the side wall of the cover is matched with the first step section 141 in a circumferential direction; the first step section 141 forms supporting and limiting to the cover; and after the cover and the shell 10 are assembled, connection may be achieved in a mode of using welding at the connection part of the cover and the shell 10. Welding may be vertical welding, that is, when a plane, in which the cover is located, is perpendicular to a horizontal plane, vertical welding is used at the connection part of the cover and the shell 10 to form a vertical welding structure.

Thus, the cover is connected with the shell 10 by welding, preferably, vertical welding, so that the effect of welding on the winding core in the shell 10 may be effectively weakened; the effect of welding laser light on a plastic part in the cover is prevented; the service life of the cover is prolonged; and the possibility of a short circuit between the cover and the winding core is lowered.

The battery according to an embodiment in second aspect of the present invention comprises the casing for the battery according to any one of the embodiments.

It is understood that the winding core of the battery is mounted in the shell 10 from one end of the shell 10; the shell 10 is provided with the first shell portion 11 and the second shell portion 12; the first shell portion 11 is connected to the second shell portion 12 through the transition portion 13; and the wall thickness of the first shell portion 11 is larger than the wall thickness of the second shell portion 12. The step portion 14 is arranged at one end, away from the second shell portion 12, of the first shell portion 11; the first step section 141 may support the cover; the second shell section 142 forms limiting to the cover; and after the cover adapts to the step portion 14, the cover is fixedly connected to the step portion 14 through a vertical welding technology. The two ends of the shell 10 may be of a single path and also double paths, that is, at least one end of the shell 10 is open; the cover may be mounted with one of the two ends and may further be mounted with the shell 10 at the two ends of the shell 10.

The battery may be a single-path battery or a double-path battery. For example, when the battery is of the single path, the body 100 only comprises one cover; the cover is arranged at one end of the shell 10, adapts to an opening of the shell 10 and is provided with an electrode pole (not shown in drawings); and the cover and the shell 10 may be connected by welding. An electrode pole may not be arranged at the other end of the shell 10; a top wall or a bottom wall of the shell 10 (when the cover is configured with the top wall, the other end of the shell 10 is configured with the bottom wall; and when the cover is configured with the bottom wall, the other end of the shell 10 is configured with the top wall) and the side wall may be an integrally formed piece; or the top wall or the bottom wall of the shell 10 may be connected with the side wall through welding. For the battery with such arrangement, the stability of a structure of the battery shell 10 may be improved; so that the battery can have good structure strength, may better protect the winding core in the shell 10 and improve the ability of the shell 10 of wholly resisting deformation.

When the battery is the double-path battery, electrode poles may be arranged at the two ends of the shell 10 respectively; and covers may be arranged at the two ends of the shell 10 respectively. The covers may both be welded to the shell 10 by welding, so that the procedure of fixing the cover is reduced, and mounting of the cover and the shell 10 is facilitated; and on the other hand, sealing to the shell 10 may be formed, and the sealing performance of the battery is improved. Or, one of the covers may be welded to the shell 10 by welding, wherein a groove a may be formed in the other cover and the shell 10 through a rolling process.

The battery may be manufactured by an opening formation process. Specifically, the winding core may be encapsulated in the shell 10 of the battery; liquid injection sealing is conducted on the battery; an electrode plate led out from the winding core is welded to the cover; and then the cover is mounted on the shell 10. The battery after being assembled is transferred to a formation workshop, and then a conduction tube is inserted into the cover, so as to conduct formation of the battery; and at this time, gas produced during formation of the battery is exhausted from the conduction tube. After formation, the conduction tube requires to be drawn out, and a channel formed by inserting the conduction tube into the cover is sealed by a sealing piece.

Thus, by arranging the step portion 14 at one end of the shell 10 and fixedly connecting the cover to the shell 10 in a welding mode, the structure strength between the shell 10 and the cover may be improved, and the effect on the winding core in the welding process is weakened; and by conducting thinning treatment on the second shell portion 12, the cost of a material for manufacturing the battery and the weight of the battery are lowered, and the energy density of the winding core is increased. With use of the opening formation process, use of a mechanical material, for example, a sealing rubber nail and a sealing aluminum nail, may be effectively lowered, and the manufacturing cost may be lowered.

In description of the present invention, it should be understood that orientations or positional relationships indicated by terms “center”, “length”, “width”, “thickness”, “upper”, “lower”, “front”, “rear”, “left”, “right”, “vertical”, “horizontal”, “top”, “bottom”, “inner”, “outer”, “axial”, “radial”, “circumferential ” and the like are based on orientations or positional relationships shown in the drawings, are to facilitate the description of the present invention and simplify the description merely, do not indicate or imply that the referred apparatuses or elements must have specific orientations and are constructed and operated in the specific orientations and thus should not be construed to limit the present invention.

In description of the present invention, “first feature” and “second feature” may comprise one or more of the features. In the description of the present invention, “a plurality” means two or more. In the description of the present invention, the first feature “over” or “under” the second feature may comprise a direct contact between the first feature and the second feature, and may also comprise a contact between the first feature and the second feature by interposing an additional feature rather than the direction contact between the first feature and the second feature. In the description of the present invention, the first feature “over”, “above” or “under” the second feature comprises that the first feature is right over or obliquely over the second feature, or merely represents that a horizontal height of the first feature is larger than that of the second feature.

In descriptions of this specification, descriptions in the reference terms “an embodiment”, “some embodiments”, “exemplary embodiment”, “example”, “specific example”, “some examples” or the like mean that the specific features, structures, materials or characteristics described in combination with the embodiments or the examples are included in at least one embodiment or example of the present invention. In the present specification, the schematic representation of the above terms does not necessarily mean the same embodiment or example.

While the embodiments of the present invention have been illustrated and described, it can be understood to those of ordinary skill in the art that various changes, modifications, substitutions and alterations can be made herein without departing from the principle and the objective of the present invention, and the scope of the present invention is defined by the appended claims and equivalents thereof.

What is claimed is:

1. A casing for a battery, comprising:
a body, wherein the body comprises a shell and at least one cover; at least one end of the shell is open; the cover is arranged at the one end of the shell; the shell comprises at least one first shell portion and a second shell portion which are connected to each other; the first shell portion is opposite to the cover; a thickness of the first shell portion is larger than a thickness of the second shell portion; and a mounting portion is arranged at the one end of the shell.

2. The casing for the battery according to claim 1, wherein an inner surface of the first shell portion is flush with an inner surface of the second shell portion.

3. The casing for the battery according to claim 1, wherein a transition portion is connected between the first shell portion and the second shell portion and has a thickness gradually increasing in a direction from the second shell portion toward the first shell portion.

4. The casing for the battery according to claim 3, wherein a thickness of one end, connected with the first shell portion, of the transition portion is D₁, and a thickness of the other end, connected with the second shell portion, of the transition portion is D₂, wherein D₁ and D₂ satisfy: D₁−D₂≥0.1 mm.

5. The casing for the battery according to claim 1, wherein a height of the first shell portion in an axial direction of the shell is larger than the thickness of the cover.

6. The casing for the battery according to claim 1, wherein the mounting portion is configured as a step portion; the step portion is arranged at one end of the shell; and the cover is supported on the step portion.

7. The casing for the battery according to claim 6, wherein the step portion comprises a first step section and a second step section which are connected to each other from inside to outside; one end, away from the center of the shell, of the second step section extends beyond an end surface at one end, away from the center of the shell, of the first step section; the cover is supported on the end surface at the one end, away from the center of the shell, of the first step section; and the first step section has a thickness D₃, wherein D₃ satisfies: D₃≥0.1 mm.

8. The casing for the battery according to claim 6, wherein the end surface at the one end of the shell is flush with a surface on one side, away from the center of the shell, of the cover.

9. The casing for the battery according to claim 1, wherein the cover is connected with the shell by welding.

10. A battery, comprising the casing for the battery according to claim 1.
